(19) United States
(12) Patent Application Publication
(10) Pub. No.: US 2009/0260064 A1
(43) Pub. Date: Oct. 15, 2009

(54) METHOD AND PROCESS FOR REGISTERING A DEVICE TO VERIFY TRANSACTIONS

(75) Inventors: Joel Richard McDowell, Shakopee, MN (US); Allan Dean Edeker, Prior Lake, MN (US); Donald Steven Overlander, Welch, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: PROBLEM RESOLUTION ENTERPRISE, LLC, Welch, MN (US)

(21) Appl. No.: 12/424,482

(22) Filed: Apr. 15, 2009

Related U.S. Application Data
(60) Provisional application No. 61/046,408, filed on Apr. 19, 2008.
(60) Provisional application No. 61/045,152, filed on Apr. 15, 2008.
(60) Provisional application No. 61/147,906, filed on Jan. 28, 2009.
(60) Provisional application No. 61/147,941, filed on Jan. 28, 2009.
(60) Provisional application No. 61/147,962, filed on Jan. 28, 2009.
(60) Provisional application No. 61/147,973, filed on Jan. 28, 2009.
(60) Provisional application No. 61/152,024, filed on Feb. 12, 2009.

(51) Int. Cl. G06F 21/00

(52) U.S. Cl. 726/4

(57) ABSTRACT

A user-oriented verification system and method provides for verification and fraud reduction in transactions. Users create verification accounts and register one or more devices with the account. Entity data provided by the user is selectively paired with device identifiers associated with registered devices. The entity/device pairs dictate the type and scope of transactions that may be entered into by each registered device. During a transaction, a requester provides entity/device information collected from a user to the verification system. If the entity/device information matches records stored by the verification system (i.e., the user has previously registered the device and associated selected entity information with the device) then the transaction is verified and notice is provided to the requester.

### CROSS-REFERENCE TO RELATED APPLICATION(S)

This application claims the benefit of U.S. Provisional Application No. 61/046,408, filed Apr. 19, 2008, entitled “Method and Process for Registering a Device to provide a Unique Level of Trust and Security for Authorization of Transactions” by Allan Dean Edeker et al., incorporated by reference herein, U.S. Provisional Application No. 61/045,152, filed Apr. 15, 2008, entitled “Method and Process for Uniquely Identifying a Device within an Anonymous Communications Network” by Allan Dean Edeker et. al., incorporated by reference herein, U.S. Provisional Application No. 61/147,906, filed Jan. 28, 2009, entitled “One Click Registration or Deregistration of a Device” by Allan Dean Edeker et al., incorporated by reference herein, U.S. Provisional Application No. 61/147,941, filed Jan. 28, 2009, entitled “Method to Prevent Media content Piracy Using a Registered Device” by Allan Dean Edeker et al., incorporated by reference herein, U.S. Provisional Application No. 61/147,962, field Jan. 28, 2009, entitled “Method for Providing Access to Secure, Serialized, or Proprietary Media content through a Registered Device” by Allan Dean Edeker et. al., incorporated by reference herein, U.S. Provisional Application No. 61/147,973, filed Jan. 28, 2009, entitled “A Method to Transfer Secure, Serialized, or Proprietary Media content through Two or More Registered Devices” by Allan Edeker et. al., incorporated by reference herein, U.S. Provisional Application No. 61/152,024, filed Feb. 12, 2009, entitled “One Click Device Validation” by Allan Dean Edeker et. al, incorporated by reference herein.

### BACKGROUND

The present invention relates to a system and method of verifying transactions to reduce fraud.

Electronic commerce (e-commerce) refers broadly to a wide variety of activities made possible by communication networks (i.e., the Internet) that allow interconnected devices to send and receive data. For instance, nearly every merchant today maintains an online website that allows users to purchase goods or services remotely. In addition to purely financial transactions, the Internet allows people to conduct personal transactions, such as providing patient information to a hospital or accessing an employer's network to work remotely. In each of these transactions, verification of the user is important to ensuring the validity of the transaction.

The popularity of these types of transactions has risen dramatically as access to the Internet from home, work, and mobile devices has improved, with millions of dollars of online transactions occurring each year. However, with the rise in e-commerce transactions has come a rise in online fraud. By some estimates, fraud on the Internet accounts for ten percent of online transactions by value, and between four to five percent of transactions by volume. For merchants, online fraud results in both the loss of products shipped to the fraudulent user and in fees and penalties charged by credit card issuers as a result of the fraudulent transaction. By some estimates, the fraud rate experienced by online retailers is equal to 1.4% of total revenue.

In one type of common e-commerce transaction, a user “visits” the website of an online merchant and through a secure transaction (e.g., Secure Sockets Layer (SSL)), provides credit card information to purchase selected goods. This type of transaction is commonly referred to as a card-not-present (CNP) transaction because the user provides the merchant with the card information but not the actual card. Fraudulent card-not-present transactions are difficult to detect because the merchant has no ability to check for identification of the user, compare signatures, etc. Typically, a merchant verifies the authenticity of the transactions (or attempts to) by relaying the credit card information provided by the user to a third party credit processor who screens for fraud by checking whether the credit card has been reported lost or stolen. This type of verification system fails to detect fraud unless the user has reported the card stolen, which is unlikely in situations in which the fraudulent user steals the credit card number, not the actual card. It typically takes three months for a user to detect this type of fraudulent activity.

Additional security measures have been proposed to remedy these shortfalls, such as digital certificates in which a merchant stores authentication data on a user's machine. However, these proposed solutions still fail to identify a large number of fraudulent transactions. For example, the digital certificate system would fail to recognize a situation in which the fraudulent user creates an account with the merchant and is therefore issued an authorized digital certificate.

In each of these scenarios, the consumer or user must rely on the security provided by a particular merchant, (i.e. merchant security) of which the user has little or no knowledge. Merchants have an incentive to provide secure transactions, but detection of fraud from the merchant-side of the transaction is difficult. So long as the credit card (or other entity data) provided by the user is valid, the merchant has little ability to determine whether the proper user is initiating the transaction. Despite these measures by merchants and others to increase the security of online transactions, Internet fraud has continued to increase each year.

In addition to online transactions that involve verifying credit card information, a number of other of online transactions also suffer from excessive online fraud. For example, the Internet has drastically reduced the cost of distributing media content such as music and movies. But the reduced distribution cost has given rise to illegal copying and distribution of digital media. To combat the loss of revenue associated with illegal copying and distribution of digital media, many distributors of digital media have added Digital Rights Management (DRM) to limit usage of the media content. For instance, purchased media content may only be loaded onto a single machine or device. However, this is frustrating to valid purchasers of content, who must repurchase content whenever replacing an old machine or device.

These fraudulent transactions, whether a fraudulent purchase from an online merchant or fraudulent transfer of media content, are fostered by an inability to authenticate or identify a valid user. In the case of fraudulent purchases, it is an inability to authenticate that the user is who he/she purports to be. In the case of fraudulent transfers of media content, it is an inability to authenticate that a user, either a secondary user or the initial user moving content to a secondary device, is a valid owner of the media content.

### SUMMARY

A verification method provides for the verification of entity data provided by a user during a transaction. The method includes collecting device identifiers from the user device and storing device identifiers collected from the user device to a verification account to register the device. Entity information is received from the user device, and selectively associated with one or more registered devices, creating entity/device pairs that are used during verification processes. A verification request received from a requester that includes an entity/device pair provided by a user to the requester is compared to the entity/device pair stored in the database. If the entity/device pair matches a record in the database, the transaction was originated from a registered device and is therefore verified. Notification to that effect is provided to the requester. If the entity/device pair does not match a record in the database, the transaction is deemed unauthorized and notification is sent to the requester to that effect.

### BRIEF DESCRIPTION OF THE DRAWINGS

FIG. 1 is a block diagram illustrating communication between a user device and a user-side verification system to provide device management and verification according to an embodiment of the present invention.

FIG. 2 is a flowchart illustrating account creation according to an embodiment of the present invention.

FIG. 3 is a flowchart illustrating account login and management according to an embodiment of the present invention.

FIG. 4 is a flowchart illustrating registration of additional devices according to an embodiment of the present invention.

FIGS. 5A and 5B are block diagrams illustrating communication between a merchant and merchant side verification system to provide device verification according to embodiments of the present invention.

FIG. 6 is a flowchart illustrating a transaction between the merchant and the merchant-side verification system according to an embodiment of the present invention.

FIG. 7 is a block diagram illustrating identification of users based on MAC addresses according to an embodiment of the present invention.

FIGS. 8A and 8B are block diagrams illustrating the registration of a device, pairing of device identifiers with credit card information, and verification of user identity based on the credit card number/device identifier pair by a merchant according to an embodiment of the present invention.

FIGS. 9A and 9B are block diagrams illustrating one-click registration of a device and one-click verification of a transaction according to an embodiment of the present invention.

FIGS. 10A and 10B are block diagrams illustrating the association of content with a registered device and a transaction allowing a user to access media content based on the association of media content with a registered device according to an embodiment of the present invention.

FIG. 11 is a block diagram illustrating a transaction of media content between devices according to an embodiment of the present invention.

### DETAILED DESCRIPTION

The present invention provides a consumer-oriented solution to verifying online or e-commerce transactions. The present invention overcomes the shortfalls of the merchant-oriented solutions provided in the prior art, which add additional security layers without initiation or involvement from a consumer (i.e., user), by providing consumers with a system and method for managing entity information provided in online transactions.

In particular, the present invention allows consumers to register with a verification system one or more devices used to conduct transactions. Registration is based, in part, on device identifiers such as media access control (MAC) addresses that are unique to each device address. Once registered, devices may be paired with select entity information such as credit card numbers. The pairings dictate the eligibility and scope of transactions that may be performed by, through, or in connection with a device.

In one embodiment, during a transaction, the merchant collects device identifiers and entity information and provides them to a verification system to determine whether the device is authorized to complete the transaction. The device identifiers and entity information may be submitted over a network communication (e.g., the Internet) in what would be described as an ‘online’ transaction or may be communicated directly to the merchant or third party using wired or wireless communication (e.g., infrared, bluetooth, radio frequency, etc.). Attempts to complete transactions using an unregistered device or a registered device that is not authorized to complete the particular transaction based upon the entity information will fail the verification process.

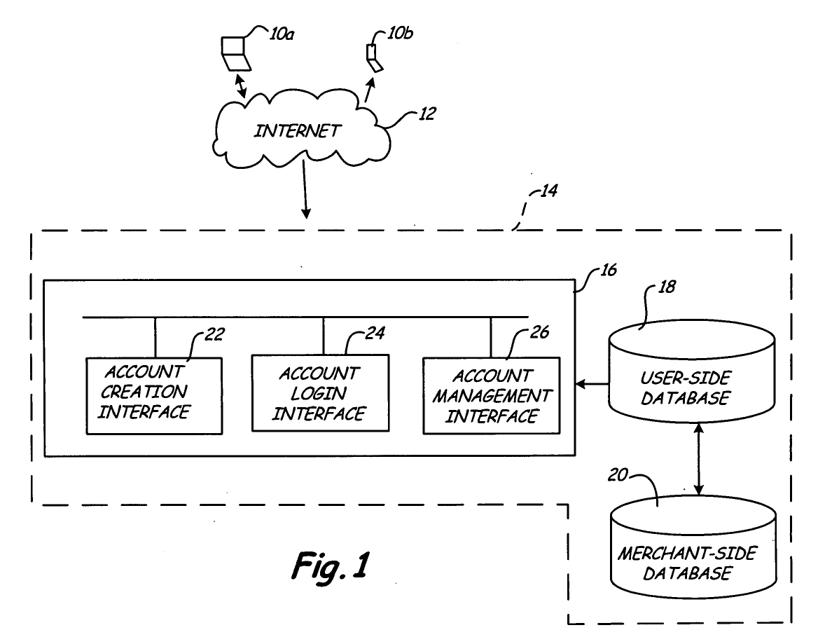

FIG. 1 is a block diagram illustrating communication between user device 10a and 10b, Internet 10, and user-side verification system 14 to allow a user to register one or more devices, pair each device with specified entity information that may be unique to each device, and otherwise manage the user's verification accounts according to an embodiment of the present invention. User devices 10a and 10b communicate via Internet 12 with verification system 14, which includes user-side server 16, user-side database 18, and merchant-side database 20. In this embodiment, user-side database 18 stores information related to an account created by a user that is responsible for storing entity data, device identifiers, as well as account related information such as username/password, user-selected means of notification, device type (e.g., computer, cell phone, cell phone brand, etc.), etc. Merchant-side database stores entity/device pairs and receives verification requests from requesting servers (e.g., merchants, third-parties, etc.) that include entity/device pairs with which the merchant-side database compares with stored values to verify transactions. In other embodiments, both functions may be performed by a single database. User-side server 16 is further represented as including account creation interface 22, account login interface 24, and account management interface 26.

User device 10a is represented here as a laptop computer and user device 10b is represented as a cell phone, but the term “user device” refers broadly to any device capable of connecting and communicating with a network (e.g., Internet) such as a mobile/cellular phone, personal digital assistant (PDA), desktop computer, etc. Likewise, communication with the Internet may be via a wired or wireless connection. In this embodiment, the term ‘Internet’ is used to describe the communication network used to communicate information between devices. However, the term ‘Internet’ should be interpreted broadly to refer to all types of communications between devices. Examples of which would include networked communications, wireless communication (e.g., Bluetooth, radio frequency, etc.), cellular communications, etc.

Each user device 10a and 10b is characterized by a unique device identifier that distinguishes one device from another. Various device identifiers may be used to distinguish between physical devices, such as media access control (MAC) addresses, device serial numbers, chip manufacturer number, board or hardware set identifier, software and/or browser version numbers, etc. It is beneficial to select a device identifier that cannot be modified by a user, or cannot be modified or ‘spoofed’ by a fraudulent user. In particular, MAC address, device serial numbers, chip numbers, and the like are beneficial in this respect because they are often-times stored in hardware, further complicating the process of fraudulently modifying device identifiers.

Verification system 14 includes user-side server 16, user-side database 18, and merchant-side database 20. User-side server 16 is a combination of hardware and software that communicates with user devices 10a and 10b via the Internet. For example, user-side server 16 may store and communicate webpages or interfaces, such as account creation interface 22, account login interface 24, and account management interface 26, to user devices 10a and 10b, allowing a user to enter information via the interface and communicate the information back to user-side server 16 for parsing. Account information provided by a user is stored to user-side database 18.

Verification of transactions first requires users to create an account on verification system 14. The device identifier associated with the device used to create the account is stored (i.e., registered) and paired with entity information provided by the user. Subsequent to account creation, the user can add/remove devices from the account (i.e., register/de-register devices), associate selected devices with various entity information (e.g., credit card information, media content, etc.), and other functions allowing the user to control how a particular device or devices are allowed to perform transactions, whether online or directly.

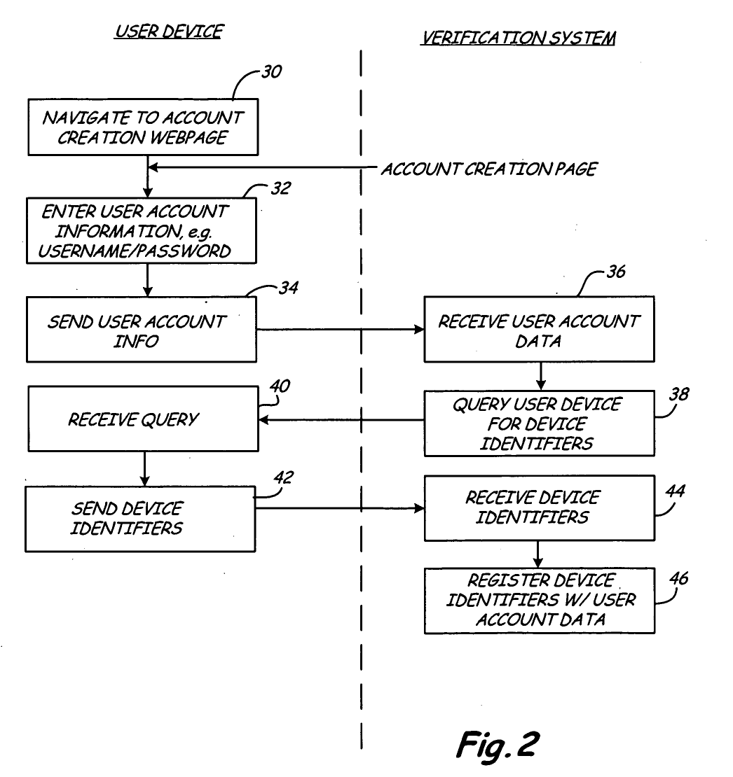

FIGS. 2-4 are flowcharts illustrating steps performed by user device 10a (and/or 10b) and verification system 14 to create an account, manage account information, and add devices to the account, respectively, according to an embodiment of the present invention. The steps performed are described with reference to the devices shown in FIG. 1. In each of FIGS. 2-4, operations performed by user device 10a (or 10b ) are illustrated on the left-side of the figure under the heading “User Device”. Operations performed by verification system 14 are shown on the right-side of the figure under the heading “Verification System”.

FIG. 2 is a flowchart illustrating account creation according to an embodiment of the present invention. As a consumer-driven approach to online security, the user is responsible for account creation and management. As such, the first requirement is for the user to create an account. At step 30 an unregistered device navigates via Internet 12 to an interface or webpage (e.g. account creation interface 22) provided by verification system 14. The interface provided by verification system 14 is displayed on user device 10a (or 10b) and includes data fields or modules that allow a user to enter information at step 32. User account information may include username and password information selected by the user that allows the user to gain access to account information as is typical on many websites. User account information may further include information identifying types of devices registered by users (e.g., an Apple iPhone™).

At step 34 the user submits the user account information, and the information is communicated from user device 10a to verification system 14, which receives the information at step 36. In response, at step 38 verification system 14 queries user device 10a for device identifiers (such as MAC address). Device 10a receives the query at step 40 and in response communicates device identifiers to verification system 14 at step 42. In one embodiment, the response by device 10a is provided automatically without intervention by a user. For example, the query provided by verification system 14 may be an applet or equivalent software module that when executed on the user device acts to locate device identifiers associated with device 10a and automatically communicate them to verification system 14. In other embodiments, the user may be presented with a button notifying the user of the request for device identifiers and requesting user interaction to permit collection of the device identifiers. In response to the user clicking or activating the button, an applet or equivalent device (either stored locally on the user's device or communicated from verification system 14) collects device identifiers and transmits them to verification system 14. In both embodiments however, device identifiers are collected by verification system 14 rather than entered and submitted by a user. In this way, the user is prevented from submitting fraudulent device identifiers. In other embodiments, rather than query the user device subsequent to submission of user account information as shown in FIG. 2, the device identifiers are collected either in response to the user device navigating to the account creation page or along with the submission of account information. For example, account creation interface 22 may include a button labeled ‘Submit and Verify Device’ that when clicked or otherwise activated by the user communicates the user account information provided by the user along with the device identifiers. Communication between user device 10a (or 10b) and verification system 14 may be encrypted or otherwise secured to further improve security of the overall system.

Having received device identifiers, at step 46 verification system 14 associates the device identifier with the user account information and stores the data to user-side database 18. By storing device identifiers associated with user device 10a, the device has become “registered.” Subsequent attempts by a user to access the created account will depend not only on user-selected identifiers such as username and password, but verification through device identifiers that the user is accessing the account from a registered device.

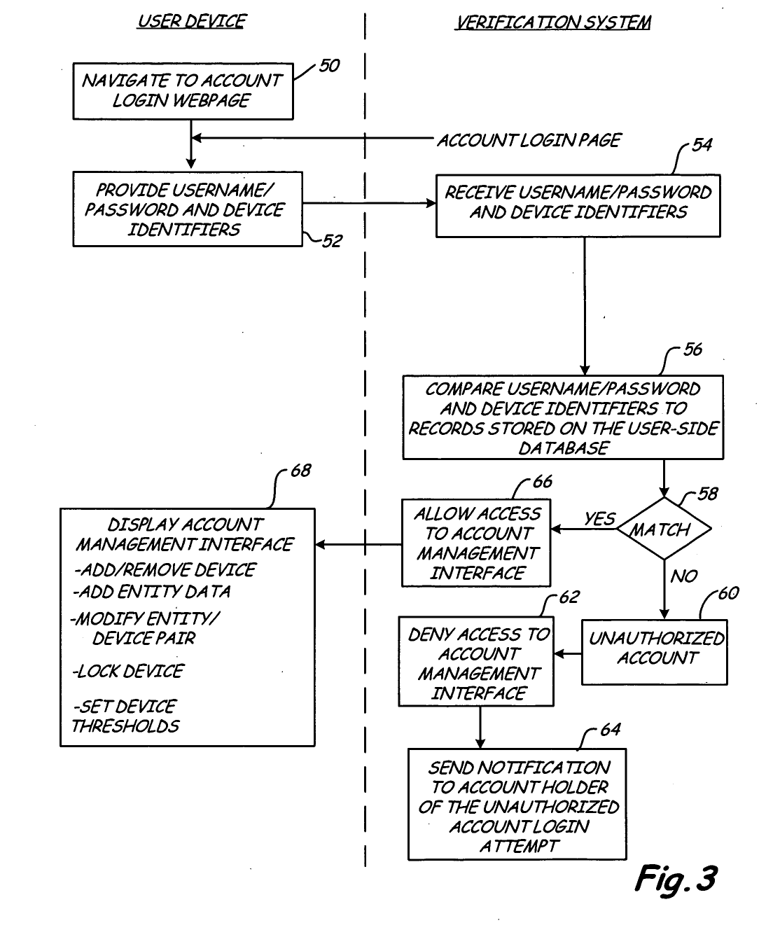

FIG. 3 is a flowchart illustrating account login and management according to an embodiment of the present invention. At step 50, the user navigates to the interface or webpage provided by verification system 14. In this instance, the user navigates to the account login interface 24 as opposed to the account creation interface 22 described with respect to FIG. 2. Using account login interface 24, at step 52 the user provides username and password information selected during account creation. In this embodiment, submission of username and password information includes automatic collection of device identifier information. In other embodiments, verification system 14 may receive username/password information and then subsequently query the user device for device identifiers. It is preferable that device identifiers be collected automatically to prevent fraudulent users from impersonating a registered user device, although in one embodiment the user may manually enter device identifiers associated with a particular device.

At step 54, the username/password and device identification data provided by the user device is received by verification system 14. At step 56, verification system 14 compares username/password information provided by the user and device identifiers to records stored in user-side database 18. At step 58, verification system 14 determines whether a match exists. If the information provided by the user does not match the stored username/password and device information data, then at step 60 verification system 14 determines that the login attempt was unauthorized. In response to an unauthorized login attempt, at step 62 verification system 14 sends notification to the user device denying access to the account management interface. In one embodiment, the user may be allowed multiple chances (defined by the verification system or selected by the user) to correctly provide username/password information. If however, a user attempts to login from an unregistered device, even with a valid username/password combination, verification system 14 will deny access to the account management interface. This prevents fraudulent attempts to modify a user's account from an unregistered device. In other embodiments, a user may choose to allow ‘open’ registration, wherein a user allows a new device to be registered remotely, then verification system 14 would require the user to go through additional security and authentication processes such as answering multiple security questions, etc.

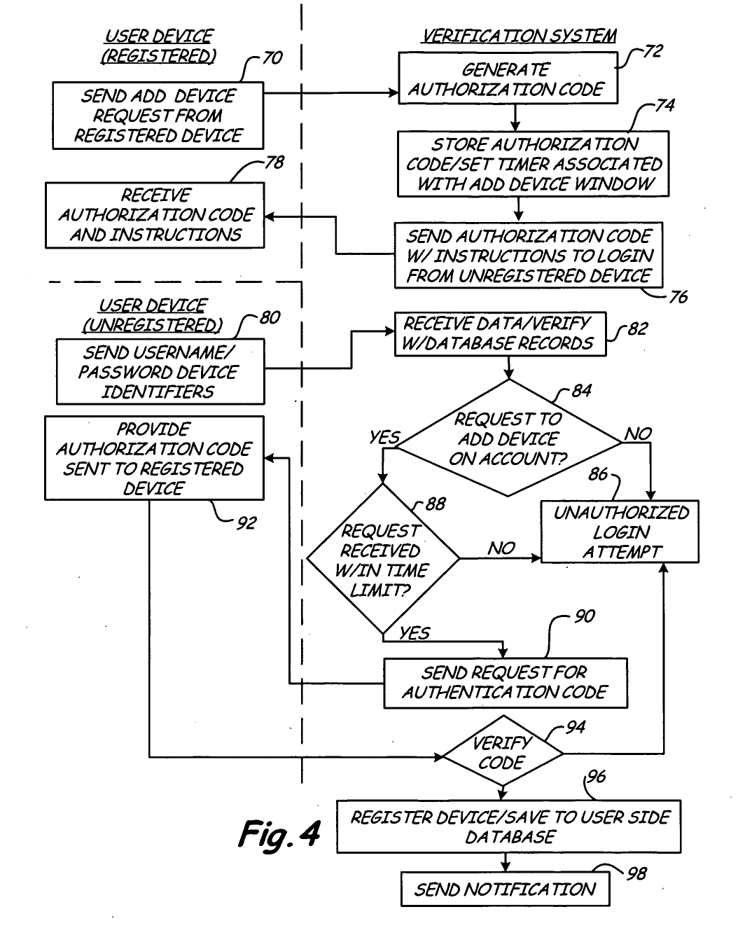

In addition to denying access to the account management interface, verification system 14 may also send notifications to the user of the account being accessed of the unauthorized login attempt. The notification is communicated to the user, not necessarily to a particular user device, by any means selected by the user during account creation, such as by email, text, voicemail, fax, etc. For unauthorized attempts in which the user provides the correct username/password combo, but does not provide them from a registered device (i.e., device identifiers do not match stored identifiers), then the notification is sent to the user of the account matching the username/password combo. This indicates a situation in which a potentially fraudulent user has gained access to a user's username/password and is attempting to modify a user's account. It may also be a situation in which an authorized user is attempting to modify his account from an unregistered device, in which case the notification instructs the user of the requirement to login from a registered device and proceed to register the additional device (which is described with respect to FIG. 4). In the event that the username/password is not found in the database, but the device identifiers match a device identifier stored for a different username/password, the notification may be sent to the owner of the account matching the device identifier. This may represent a situation in which a fraudulent user has gained physical access to a user's device and is attempting to modify the user's account with the device. In this case, providing a user notification to the user associated with the device identifier is more useful. Because both the username/password information and device identifier information are unique to individual users, sending a notification to the user associated with whichever piece of information is correctly provided results in the proper user being notified of the unauthorized login attempt.

At step 66, if the username/password combo and device identifier information is correct, indicating that a valid user is attempting to access his/her account from a registered device, then verification system 14 provides the user with access to account management interface 26. At step 68, the account management interface is displayed on the user device, allowing the user to take actions such as adding/removing (i.e. registering/deregistering) devices to the account, adding entity data (e.g., credit card information, media content, etc.), modifying pairings of registered devices with select entity information, locking devices, and setting device thresholds (e.g., transaction limit of $100 associated with a particular device). In addition, the account management interface allows the user to change passwords, account status, etc. Modifications or changes made to the user's account are communicated to verification system 14 at step 70, and stored by verification system to user-side database 18 at step 72.

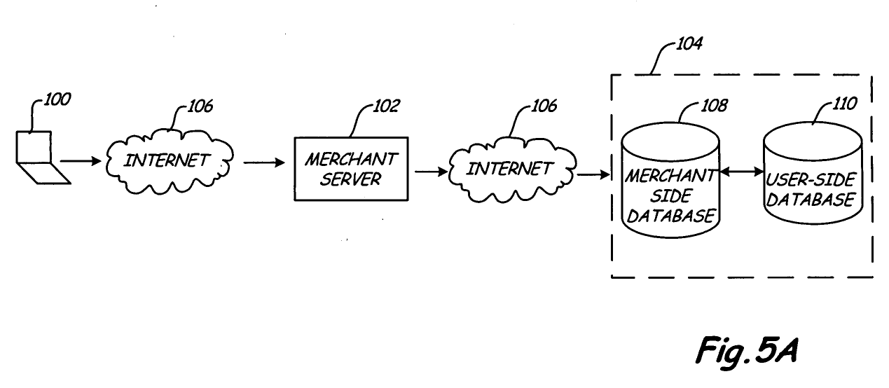

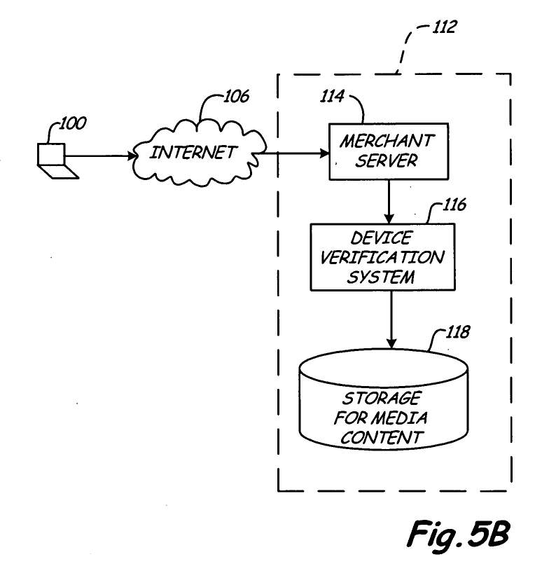

As described above, entity data refers broadly to a range of user information necessary for online transactions. For example, a user's credit card number(s) represents one class of entity data that a user may associate with a particular device. During an online transaction, the user would provide the merchant with the credit card number. By pairing the credit card number with a registered device (i.e., device identifiers associated with the registered device), the user limits the use of the credit card (for example, in card-not-present transactions) to transactions occurring from or involving the registered device. Associating entity information with registered devices results in the creation of a device/entity pair that is stored with respect to the user's account on user-side database 18. In addition, the device/entity pair is provided by user-side database 18 to merchant-side database 20. The device/entity pair stored on merchant-side database 20 and compared with entity data/device interface collected by the merchant during online transactions (or provided directly from the user to verification system 14 without interaction by the merchant) to prevent fraudulent uses of entity information from unregistered device, described in more detail with respect to FIG. 5A).

In other embodiments, entity information may include the user's name, address, social security number, security questions and answers, or other information that is unique to the user and that the user wishes to associated (or just as important, select not to associate) with one or more registered devices. In one embodiment, for entity data unique to a user (such as credit card numbers, social security numbers, etc.), verification system 14 only allows entity data to be added or associated with a single user account. By adding entity data to an account, but selecting not to associate the entity information with any registered devices, the user effectively prevents other users from fraudulently attempting to add user data to their own accounts and associating the entity data with their own registered devices.

In addition to unique or quasi-unique entity information, entity information may relate to digital media content, such as movies, music, etc. that a user has purchased. This may include content that a user has downloaded and stored locally, in which the rights associated with the media content may include usage limits, expirations, etc., or content that a user has purchased the right to access, but which is stored remotely by a third party (i.e., cloud storage). For example, a user may purchase a particular song online, but rather than download the song and store it locally, the user may essentially purchase the right to access the song (stored in a database by the merchant/content provider). For this type of entity data, it would be beneficial to the merchant or third party responsible for storage of the media content to be able to verify access to selected content.

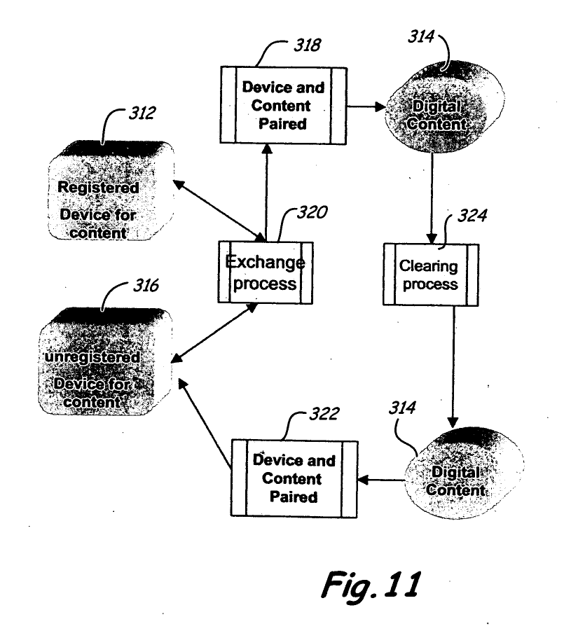

With the present invention, the media content (e.g., song, movie, etc.) represents entity information that a user may manage through the account management interface to associate with particular devices. Access to the song is limited to registered devices paired with the song by the user and/or the merchant. The pairing or association between the song and the registered device is verified by the merchant/content provider and/or third party verifier. In this way, access to particular media content may be verified by the merchant. Perhaps more importantly, this method of controlling access to media content allows a user to selectively associate media content with various registered devices. For example, a user that purchases a new desktop computer would be able to register the new computer and associate with the newly registered device all content previously associated with an old computer registered by the user. In another example, a user may sell a media content to another user. As a part of the transaction, entity information (e.g., song)/device identifier pair stored on the seller's account is erased, and a new entity/device pair associated with the buyer's account is created (an embodiment of which is described in more detail with respect to FIG. 11). In this way, the present invention provides a mechanism by which access to media content may be verified by a merchant/content provider and/or third party verifier and/or legally transferred between different users without the transferor retaining use of the content unless permitted by the merchant/content provider.

Account management interface 26 therefore allows a user to add disparate types of entity information to a particular account. Entity data added by a user is stored to user-side database 18. In addition, the account management interface allows a user to pair entity data with one or more registered devices, and continually modify these pairings as desired. As described in more detail with respect to FIG. 5A, user transactions with a merchant are verified by comparing user provided entity information and device identifiers associated with the device used to conduct the transaction to verify the authenticity of the transaction.

In one embodiment, account management interface 26 provides a listing of all registered devices and entity data. A user creates an entity/device pairing by clicking and dragging the entity information to a particular device. In response to an entity/device pairing, verification system 14 stores the entity/device pair to user-side database 18 and merchant-side database 20. Account management interface 26 may also show all entity data associated with a particular device, with modules or buttons that allow a user to highlight or otherwise select entity information to be disassociated (i.e., un paired) with the registered device. In response to an unpairing of entity data and device, verification system 14 modifies records stored in user-side database 18 and merchant-side database 20.

In addition to adding entity data and modifying associations between registered devices and entity data, the account management interface allows a user to set thresholds associated with each device/entity pair and lock devices. For example, a device/entity pair that includes a credit card number associated with a mobile device may include a transaction threshold defined by a dollar amount (e.g., $100). Attempts to conduct transactions exceeding the threshold, even with a correct entity/device pairing, will fail. This allows users additional discretion to manage and limit the extent of fraud that may be perpetrated. For devices like cell phones, which may be more likely to become lost or stolen, the user may wish to set low threshold limits that prevent the device from making large transactions. Likewise, in the event a device (e.g., cell phone) is lost or stolen, the account management interface allows the user (assuming the user has logged in from a registered device) to temporarily lock the lost or stolen device to prevent any transactions from occurring from the device. If the device is later found, the lock may be removed. Thresholds or locks set by a user are stored by verification system 14 to user-side database 18 as well as merchant-side database 20.

Finally, account management interface 26 allows a user to selectively add/remove devices from the account. Removing a previously registered device from an account is fairly straightforward, as it only requires the user to login from a registered device and select those devices to be removed. The selected device is erased from user-side database 18 and any entity/device pairs stored on merchant-side database 20 are similarly erased. To add a device, previously unregistered, requires added security to prevent unauthorized users from fraudulently adding devices which they are in possession of to a user account and associating stored entity data with the devices.

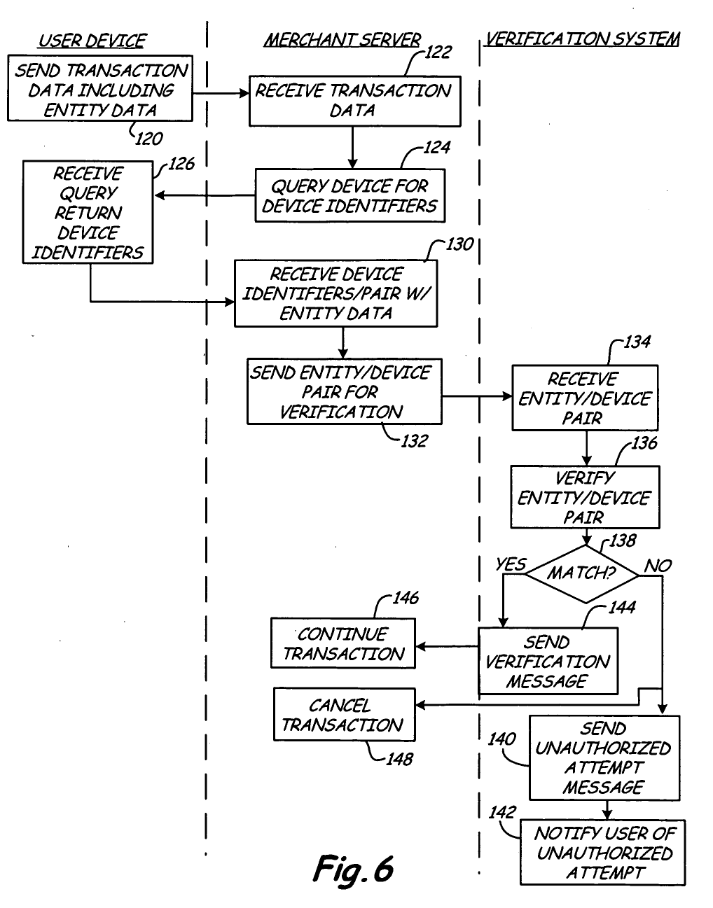

In the embodiment described with respect to FIG. 3, entity/device identifier pairs are stored for the purpose of verification on merchant-side database 20. In other embodiments, the entity/device identifier pairs are additionally stored locally on each registered device. That is, a registered device associated with select entity information would include local storage for maintaining links between entity data and device identifiers. As described in more detail below with respect to FIGS. 5 and 6, describing the verification process, local storage of entity/device pairs would prevent third party merchants from having to include the capability of collecting device identifiers. That is, part of the transaction between registered device and third party merchant would include the registered device providing the entity/device identifier pair, typically encoded as an authentication key.

FIG. 4 is a flowchart illustrating registration of additional devices according to an embodiment of the present invention. With respect to FIG. 4, device 10a will be referred to as the registered device and device 10b will be referred to as the unregistered device. FIG. 4 similarly assumes that a user has successfully logged into the account management interface 26 from registered device 10a by providing a correct username/password combo.

At step 70, the user sends an add device request from registered device 10a. Any attempts to add a device from an unregistered device will fail. At step 72, verification system 14 receives the add device request and generates in response an authorization code that is stored on user-side server 18 at step 74. In one embodiment, a timer is set that defines a length of time the user has to add a new device before expiration of the authorization code. In another embodiment, a flag or other notification may be set with respect to the user account indicating expectation of a new device being added. In this way, an attempted login by the user from the unregistered device will not result in automatic denial of access to the account management interface (as described with respect to FIG. 3), but will instead prompt the user for the authorization code. The authorization code is communicated to registered user device 10a at step 76.

The user receives the authorization code at step 78. In one embodiment, subsequent attempts to login to verification system 14 from registered device 10a (or other registered devices) will nullify the authorization code provided by verification system 14. For example, the flag identifying user intent to add a device may be removed, or the authorization code may be discarded from user-side database 18.

At step 80 the user provides username and password information from unregistered device 10b. Along with the submission of username and password information, either automatically or in response to a query from verification system 14, unregistered user device 10b provides device identifier information. At step 82, verification system 14 compares the data provided by user device 10b to records stored by user-side database 18 and, assuming the user is in fact attempting to login from an unregistered device, will determine that the device identifier provided does not match stored records. At step 84, validation system 14 checks whether a request to add a new device exists on the account. As discussed above, this may be indicated by a flag stored on the user's account, or may be based on the presence of an authorization code. If there is no request to add a new device to the account, then at step 86 the login attempt is regarded as an unauthorized login attempt from an unregistered device and notifications are provided as described with respect to FIG. 3.

In the embodiment shown in FIG. 4, at step 88 verification system 14 also checks whether the time limit to add the unregistered device has expired. If the time limit has expired, then the login attempt is regarded as an unauthorized login attempt and notifications are provided as described with respect to FIG. 3. If the timer has not expired, then at step 90 verification system 14 sends a request to unregistered device 10b for the authentication code.

The user provides the authorization code to verification system 14 at step 92 and verification system 14 verifies that the code from unregistered device 10b matches the authorization code generated at step 94. If the authorization code does not match, then unregistered device 10b is not registered and the login attempt is identified as an unauthorized attempt at step 86. If the authorization code provided by unregistered device 10b matches the generated authorization code, then the device identifiers associated with unregistered device 10b are associated with the user account and saved to user-side database 18 at step 96. In addition, a notification is sent to the user (via communications means selected by the user, e.g., email, text, phone call, etc.) notifying the user of the registration of an additional device on the account at step 98. Successful registration of the device allows the user to access the account from the newly registered device, thereby allowing the user to associate select entity data with the newly registered device.

Having described the method by which a user creates, logins, and manages a verification account, the process by which a user conducts an online transaction using the verification account is described.

FIG. 5A is a block diagram illustrating communication between registered user device 100, merchant server 102, and verification system 104 via Internet 106 to provide device verification according to an embodiment of the present invention. In this embodiment, device 100 is assumed to have been previously registered on verification system 104 as described with respect to FIGS. 1-4, with entity/device identifier pairs stored to merchant-side database 108 (as well as user-side database 106). Likewise, merchant server 102 represents a third party with which the user wishes to transact, and may be for purposes other than commercial transactions. Typically, merchant server 102 would include storage for webpages used to conduct transactions for merchandise or services, but may included transactions between individual users as well. Verification system 104 communicates with merchant server 102 during a transaction (as opposed to communicating with user device 100) and includes merchant-side database 108 and user-side database 110.

During a transaction, user device 100 communicates entity information (e.g. credit card information) to merchant server 102. Communication between user device 100 and merchant server 102 is typically secured through means such as secure sockets layer (SSL) or equivalent secured communication channel. This prevents fraudulent users from ‘listening’ to communications between user device 100 and merchant server 102.

Device identifiers associated with user device 100 are collected by merchant server 102 and the combination of entity information and device identifiers are provided for verification to verification system 104. The entity/device pair received by verification system 104 is compared to entity/device pairs stored on merchant-side database 108 to validate that the entity information was in fact provided by a registered device. Based on the result of the comparison, verification system 104 provides an indication to merchant server 102 verifying that the entity information provided to the merchant is associated with the device that submitted the entity information. The merchant may additionally verify the status of the entity information provided by the user. For example, merchant server 102 may request verification from a card issuer that a particular credit card number has not been reported lost or stolen.

The benefit of verifying that the transaction was originated from a registered device is not only that it provides an additional level of security, but that the additional level of security is controlled and managed by the user. Unauthorized attempts to fraudulently use registered entity data will result in denial of the transaction as well as notification to the account holder of the fraudulent attempt.

FIG. 5B is a block diagram illustrating communication between registered user device 100 and merchant/content provider 112. In contrast with FIG. 5B, in this embodiment merchant/content provider 112 provides local verification of the transaction without requiring the merchant server to communicate entity/device pairs to a verification system. Although applicable to any type of transaction, FIG. 5B is directed in particular to the process of verifying access to media content stored by merchant/content provider 112. In this embodiment, merchant/content provider 112 includes merchant server 114, verification system 116, and media content storage facility 118.

In the embodiment shown in FIG. 5B, device 100 is once again assumed to have been previously registered on verification system 116. However, because verification system 116 is local to merchant/content provider 112, a user may have to separately register devices to interact with other merchant/content providers. Registration may be initiated by the user or may be done automatically for all customers who purchase media content from merchant/content provider 112. Either during the registration process or subsequent to the registration process, device identifiers identifying user device 100 are selectively paired with media content purchased by a user (i.e., entity data). The pairing indicates the selected media content available to the user and the devices from which the user is allowed to access the selected media content.

In one embodiment, merchant server 114 provides an interface that allows a user to selectively control the pairings of entity data with registered devices. The selected pairings being stored by verification system 116. From the interface provided by merchant server 114, the user may purchase access to additional media content (i.e., add entity data), modify the registered devices allowed to access the media content (i.e., selectively modify the stored entity/device pairings), and access media content stored by media content storage facility 118.

In the embodiment shown in FIG. 5B, to access select media content, user device 100 communicates information identifying the media content to be accessed to merchant server 114. Device identifiers associated with user device 100 are collected by merchant server 114 and the combination of media content and device identifiers are provided for verification to verification system 116. The media content/device identifier pair received by verification system 116 is compared to media content/device identifier pairs, previously stored to verification system 116, to validate access to the identified media content. If the verification is successful, then the selected media content is made available to user device 100 from media content storage facility 118. If the verification is unsuccessful, either because the user does not have access to the indicated media content, or the user is attempting to access the media content from an unregistered device, then media content is not made available to user device 100.

In other embodiments, media content storage facility 118 may be provided by a third party wholly separate from the merchant/content provider. In this embodiment, verification of entity/device pairs may be provided without the merchant server 114 acting as an intermediary. That is, media content storage facility 118 may verify access to content stored by the facility, or may receive requests from users and transmit those requests (including entity/device pairs) to a separate verification system to verify access.

FIG. 6 is a flowchart illustrating a transaction between a user and a merchant, with verification provided by verification system 104 according to an embodiment of the present invention. In another embodiment, a merchant/content provider provides internal verification, in which the operations performed by the merchant server and the operations performed by the verification system would be performed by a single entity (i.e., merchant/content provider). Operations performed by user device 100 are illustrated in the left column under the heading “User Device.” Operations performed by merchant server 102 are illustrated in the central column under the heading “Merchant Server.” Operations performed by verification system 104 are illustrated in the right column under the heading “Verification System.” At step 120, user device 100 communicates transaction data to merchant server 102. This may include username/password combinations (although the username/password combo may differ from the username/password combination provided to access verification system 14 as described with respect to FIGS. 1-4) and entity information. As described above, entity data provided by user device 100 may include information such as credit card numbers, digital media content (or information identifying particular digital media content), or other information critical to conducting the transaction with merchant server 102.

In the embodiment shown in FIG. 5A, merchant server 102 receives the transaction data at step 122. In response to the received transaction data, merchant server 102 queries user device 100 for device identifiers. At step 124, user device 100 receives the query and responds with device identifier information. In other embodiments, the decision by the user to transmit transactional data including entity data is coupled with an automatic transmittal of device identifiers. Preferably, the user does not have any control or input over the device identifiers provided by user device 100 whether provided automatically along with transactional data or in response to a query from merchant server 102.

In other embodiments, user device 100 may include local storage for entity/device identifier pairs. In this embodiment, merchant server 102 would not be required to query and collect device identifiers from user device 100. Rather, user device 100 supplies the proper entity/device identifier pair (typically encoded as an authorization key), which merchant server 102 passively communicates to verification system 104.

At step 130, merchant server 102 pairs the entity information provided by the user with device identifiers collected from user device 100 (either collected individually, or communicated as an entity/device pair by user device 100). The entity data/device identifier pair is sent to verification system 104 to verify the transaction at step 132. In response to the entity/device identifiers received by verification system at step 134, the pair is compared with records stored on merchant-side database 108 to determine whether the pair is valid. That is, using the account management interface described with respect to FIGS. 1-4, the user must have previously associated the entity information and the device being used to submit the entity information to merchant server 102 with one another.

If the entity data/device identifier pair provided by merchant server 102 does not match records stored on verification system 104 (i.e., on merchant-side database 108), then at step 140 the transaction is identified as unauthorized and a notification is sent to merchant server 102 identifying it as such. In response, merchant server 102 may cancel the transaction and send a notification to user device 100. In addition, in the event of an unauthorized transaction attempt, verification system 104 may automatically send a notification of the unauthorized attempt to the account holder (as determined based on the entity and/or device identifier information). The notification may be sent to the account holder email, text, phone message, or other, as selected by the user from among the options offered by verification system 104. The notification provided by merchant server 102 to (unauthorized) device 100 simply states that the transaction failed. The notification provided by verification system 104 attempts to alert the account holder of the attempted unauthorized transaction.

If the entity data/device identifier pair provided by merchant server 102 matches a record stored on verification system 104 (i.e., on merchant-side database 108), then at step 144 verification system 104 sends notification to merchant server 102 that the transaction has been verified. Based on the response from verification system 104, merchant server 102 may continue with the transaction. A notification may also be sent notifying the user of the transaction of the verified transaction. Typically, record of the transaction is maintained and provided to the user in a weekly, monthly, and/or quarterly report describing the transactions performed within the said time period as selected by the account holder.

In addition to verifying a particular transaction, verification system 104 may also determine to various degrees of particularity which system has been compromised. For example, in one embodiment merchant server 102 collects entity/device information from user device 100. The communication between merchant server 102 and user device 100 is typically secured (via secure sockets layer, or other equivalent security means). The entity/device information communicated from user device 100 is further paired with information specific to merchant server 102. An example of this would be price associated with the user transaction. This information is typically not communicated between user device 100 and merchant server 102. In one embodiment, the combination of information provided by the user (e.g., entity/device data) and information specific to the merchant (e.g., price info) is combined and encrypted before being transmitted to verification system 104. In addition, the communication between merchant server 102 and verification system 104 is also typically secured, such as through SSL layers described above. To verify the operation, verification system 104 decrypts the message provided by merchant server 102 and compares the entity/device pair to stored entity/device pairs, as described above.

Verification system 104 detects fraudulent points of entry into the communication system based on the information provided by merchant server 102. For example, if the encryption method provided by merchant server 102 does not match the expected encryption method, then verification system 104 determines that the message was not in fact provided by a verified merchant, but rather a fraudulent merchant attempting to pose as a verified merchant in an attempt to locate valid device/entity pairs. In this example, verification system 104 does not provide a notification of verification, but may provide an alert to an account holder matching the device/entity pair provided or to the merchant being impersonated by the fraudulent merchant.

If the encryption method matches that provided by merchant server 102, but the merchant specific information (e.g., price information) is incorrect or not included as part of the transmission, then verification system may determine that the encryption methods provided by merchant server have been compromised. That is, the fraudulent merchant knows how to encrypt information provided to the merchant by a user, but does not have knowledge of how data internal to merchant server 102 is encrypted for transmission to verification system. In this case, verification system 104 can send notification to the verified merchant being impersonated by fraudulent merchant server 102 of the security breach (and refuse to validate the fraudulent transaction).

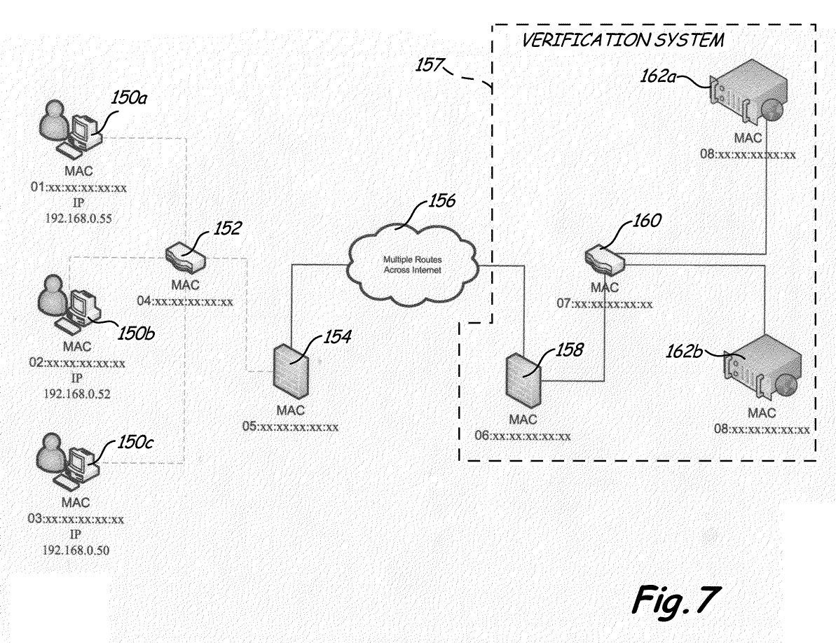

FIG. 7 is a block diagram illustrating user identification based on MAC addresses according to another embodiment of the present invention. The system shown in FIG. 7 includes a plurality of user devices 150a, 150b, and 150c (collectively user devices 150) connected through router 152 and firewall 154 to Internet 156. Verification system 157, which includes firewall 158, router 160, and servers 162a and 162b, maps individual MAC addresses (partial or complete) associated with communications from user devices 150 to IP routes associated with those devices in order to uniquely identify individual users without input or response from users. This allows the present system to identify the ‘uniqueness’ of a particular event (i.e., an event initiated by a particular user). This may be beneficial in online transactions, such as advertising, in which it is undesirable to spend revenue dollars displaying the same advertisement to a user that clicks or navigates to a page or advertisement a plurality of times.

Each user device 150, router 152 and firewall 154 is characterized by a MAC address that does not change. In addition, each user device 150 is characterized by an Internet Protocol (IP) address that may change over time (i.e., dynamic IP addressing), in particular if a user disconnects from the Internet and then reconnects resulting in a new IP address being assigned. In this embodiment, rather than a user registering a particular device with verification system 157, verification system identifies the uniqueness associated with a user transaction by pairing available network transmission information (i.e., IP routing addresses) with the whole or partial MAC address of a user device independent of any input or response from the controller or user of user devices 150. For instance, verification system 157 may store to server 162a and/or 162b data that includes MAC addresses of devices, collection of IP routes, and frequency of similar patterns to distinguish between devices. In one embodiment, verification system 157 may not be capable of accessing the MAC address of a particular user device (e.g., user device 150a). In lieu of the MAC address of the particular device, verification system 157 may store the MAC addresses of nearby devices, such as router 152, firewall 154 with which the device communicates. Subsequent communications and information collected from these communications are compared by verification system 157 to previously stored communications to determine whether the communication originated from the same user (i.e., the user event is not unique).

The pairing of information (e.g., MAC addresses and IP addresses) allows verification system 157 to verify a user of a particular device (e.g., user device 150a) despite changes to the IP address of the device. In this way, a user is prevented from fraudulently being represented as a ‘new’ device for purposes of event-based transactions such as advertising, purchase transactions, etc.

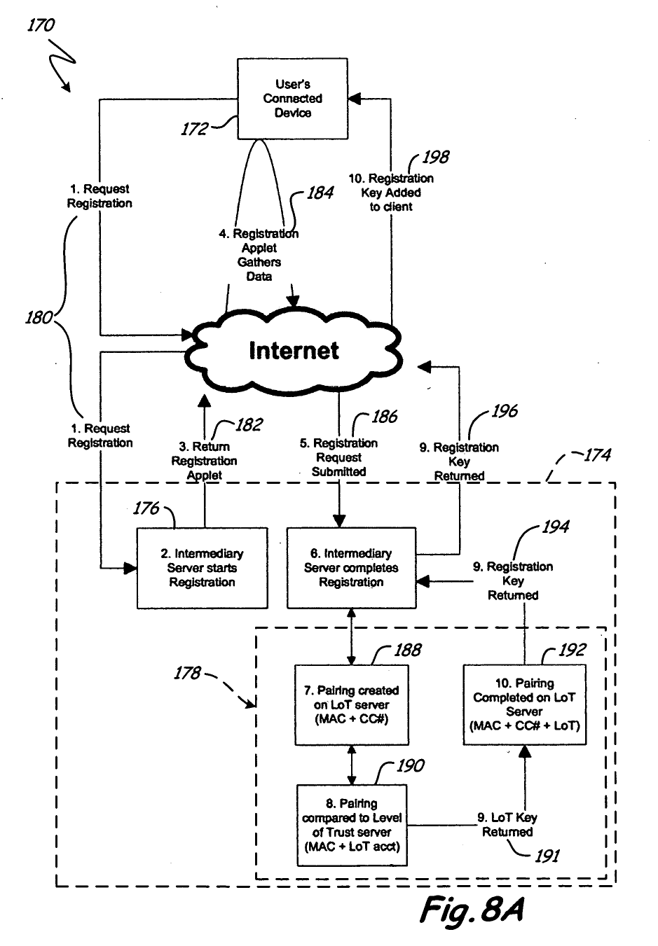

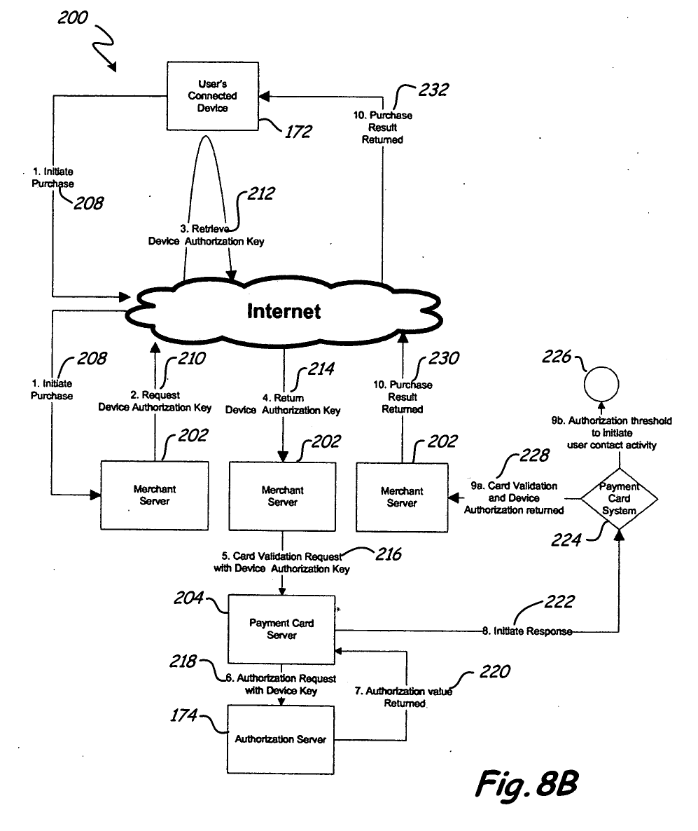

FIG. 8A is a block diagram illustrating registration of user device 172 with verification system 174 according to an embodiment of the present invention. Verification system 174 includes intermediary server 176 and level of trust (LoT) server 178.

At step 174, user device (unregistered) 172 sends a registration request to verification system 174 (via Internet 173). The request is received by intermediary server 176. In response, intermediary server 176 returns a registration applet to user device 172 at step 182. The registration applet automatically collects device identifiers, such as MAC addresses, hardware serial numbers, etc. at step 184 and transmits the collected device identifiers to intermediary server 176 at step 186. In addition, the registration applet prompts the user for entity information (e.g., credit card information) to be associated with the registered device that is also submitted to intermediary server 176. In this embodiment, entity information refers to credit card information and device identifiers refer to MAC addresses associated with each device.

Intermediary server 176 provides the collected information, including the collected MAC address and provided credit card information to level of trust (LoT) server 178 (i.e., a secure server). At step 188, the MAC address of user device 172 is paired with credit card information provided by the user on LoT server 178. Creating the credit card/MAC address pair on LoT server 178 results in the creation of a record number or account number used to identify the user's account. At step 190, this internal number (i.e., LoT key) associated with LoT server 178 is selected based on the MAC address of the user device and record number (i.e., LoT account). At step 191, the LoT key selected at step 190 is returned and at step 192 is paired with the credit card/MAC address pair to create a registration key (i.e., MAC+CC#+LoT) that is stored on LoT server 178. The registration key may be a simple combination of the device identifier, the entity information and the LoT key, or may represent an encrypted version of the combination.

Unlike the embodiments described with respect to FIGS. 1-6, in which entity/device pairs are stored by a verification system, in this embodiment, the registration key is stored on LoT server 192, but also returned to intermediary server 176 at step 194 and communicated to user device 172 at steps 196 and 198 for local storage on user device 172. In other embodiments, LoT server 192 stores credit card/MAC address pairs but does not provide the information to user device 172 for local storage. During a subsequent transaction, a third-party or merchant server is responsible for collecting credit card/MAC address information from a user device and providing it to verification system 174 for comparison. In this embodiment, however, the registration key is stored locally on user device 172 (now registered). Online transactions, described with respect to FIG. 8B, require the third-party server or merchant to request the authorization key stored on the user device 172.

FIG. 8B is a block diagram illustrating a verified transaction between user device (registered) 172 (as described in FIG. 8A), merchant server 202, payment card server 204, and authorization server 206 according to an embodiment of the present invention.

At step 208, user device 172 sends a communication to merchant server 202, via the Internet, to initiate a purchase. In response to the purchase request, merchant server 202 sends a request for the device authorization key at step 210. In the embodiment described with respect to FIG. 8A, the device authorization key (i.e., the pairing of credit card information with device identifiers) is stored locally by the registered device. At step 212, either automatically or with permission from the user, the authorization key is retrieved from user device 172. Merchant server 202 receives the device authorization key at step 214.

At step 216, merchant server makes a verification request to payment card server 204 to validate the credit card information and purchase request provided by user device 172. The request includes the authorization key provided by user device 172. At step 218, payment card server 204 makes a subsequent verification request to verification system 174 (as described with respect to FIG. 8A). In other embodiments, merchant server 202 makes a verification request that is provided directly to verification system 174 without interaction from payment card server 204. Likewise, in embodiments in which the merchant server maintains its own verification system, merchant server 202 makes a verification request that is provided to an internal verification system 174. In response to the verification request, verification system 174 compares the device authorization key (credit card/MAC address/LoT account pair) provided by payment card server 204 with the stored device authorization key. At step 220, a response is provided by verification system 174 indicating whether the device authorization key matched a stored device authorization key. At step 222, payment card server 204 initiates a response that is provided to payment card system 224 indicating whether the transaction has been validated. At step 228, payment card system 224 provides, based on the response provided by verification system 174, a response to merchant server 202 verifying that initiation of the transaction by a registered device coupled with entity information properly paired with the registered device (i.e., the credit card/MAC address pair registered as described in FIG. 8A matches the credit card/MAC address pair provided during the purchase transaction). If the verification fails, then payment card system 224 may initiate user contact at step 226 to notify the user of the failed or attempted fraudulent transaction attempt.

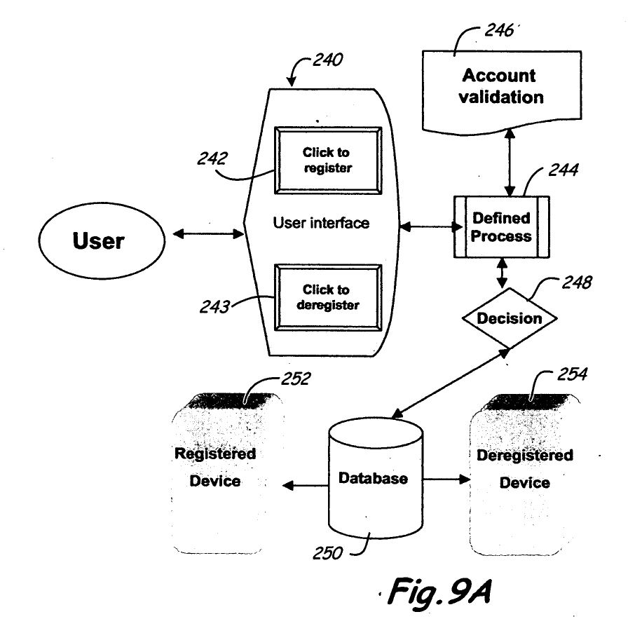

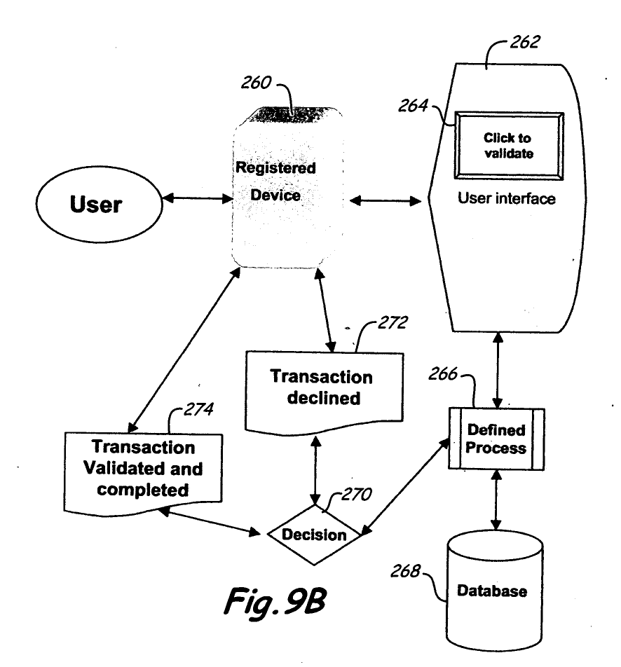

FIGS. 9A and 9B are block diagrams illustrating one-click registration of a device and one-click verification of a transaction according to embodiments of the present invention.

With respect to FIG. 9A, having accessed or created a user account using account validation process 246, the user may register/deregister a device using a one-click interface 240. To register a device, a user clicks or otherwise activates ‘Click to Register’ button 242. This initiates a defined process 244 that collects device identifiers (e.g., MAC address) from the user device. At step 248, the device identifiers are compared to device identifiers stored in database 250 to determine whether the device identifier has previously been associated with a different user account. If the device has previously been registered with a different user account, then registration of the device fails. If the device has not been previously registered, then the device identifiers are associated with the user account and stored to database 250.

To deregister a device, a user clicks or otherwise activates ‘Click to Deregister’ button 243. Devices may be deregistered using any device registered with a particular account. That is, a user does not need to access the account from the device the user wishes to deregister. By activating the ‘Click to Deregister’ button, defined process 244 accesses database 250 and removes information from database 250 associated with the device the user wishes to deregister. Subsequent attempts to perform online transactions or access the account from the deregistered device will fail.

In FIG. 9B, having previously registered a device with the verification system, a user validates a transaction with an action such as a single click. In this embodiment, a user has initiated an online transaction and as part of that transaction has been asked to validate the user device initiating the transaction. For instance, as described with respect to FIG. 8A, a merchant server requests an authorization key from a user device at step 212. In other embodiments, a merchant or third-party server may request device identifiers from a user device using an interface such as that shown in FIG. 9B. In response to the request, the user provides validating information (e.g., authorization key, entity/device pairs, etc.) by clicking or otherwise activating the ‘Click to Validate’ button 264. In response to activating the button, defined process 266 collects the validation information and compares the validating information provided by user device 260 to database 268 to determine whether the provided information matches information (e.g., entity data/device identifier pairs) previously registered and stored to database 268.

Based on the result of the comparison, a decision is made at step 270 regarding whether to accept or decline the transaction. If the validating information does not match information stored in database 268, then notification is provided to the merchant or third-party server, which may elect to decline the transaction at step 272. If the validating information matches information stored in database 268, then notification verifying the entity/device pair is provided to the merchant or third-party server, which may elect to complete the transaction at step 274.

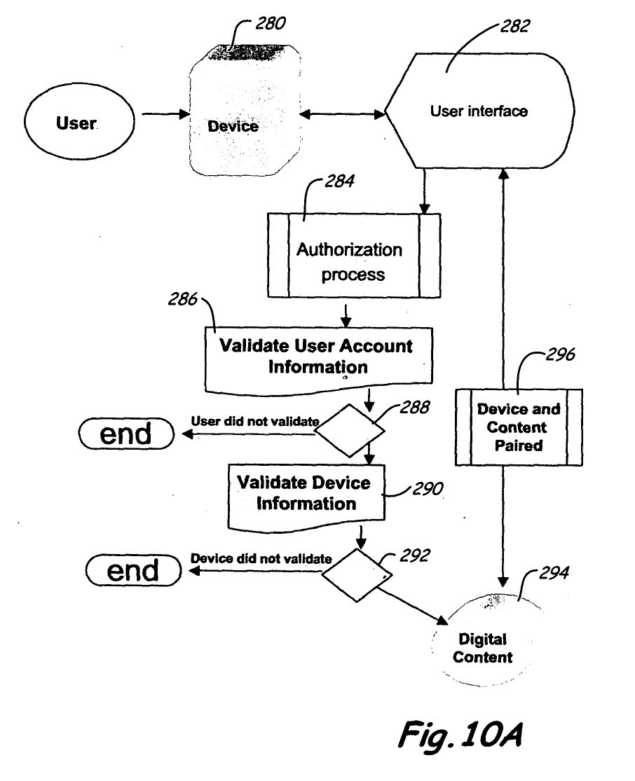

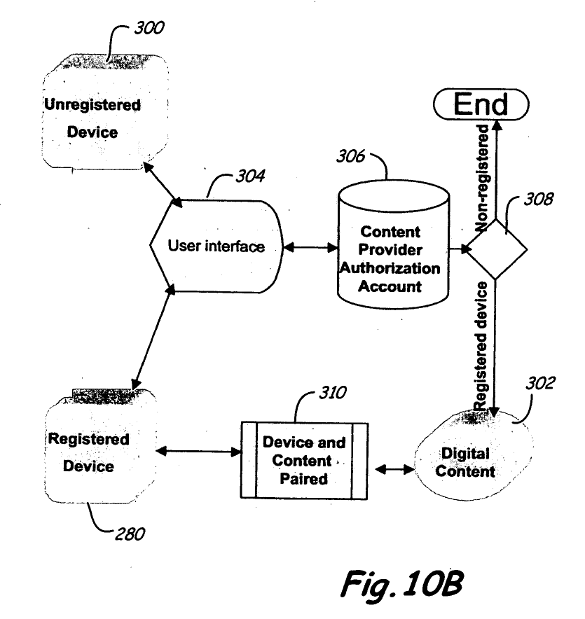

FIGS. 10A and 10B are block diagrams illustrating the association of media content with a registered device and a transaction allowing a user to access media content based on the association of media content with a registered device according to an embodiment of the present invention.

FIG. 10A illustrates the method by which a user prevents the piracy or theft of media content by associating media content with a particular registered device 280. User interface 282 allows a user to create and/or access a user account. Assuming the user has previously created a user account with a verification system (for example, as described with respect to FIGS. 1-3), then at step 284 a user provides user account information (e.g., username, password, etc) to initiate the authorization process. In other embodiments, user account information may not be required, only information related to entity/device pairs. At step 286, the authorization system compares the user account information with stored user account information to validate the authorization of the user to access a particular account.

At step 288, if the account information cannot be validated, then the validation system ends the process and prevents the user from accessing the use account. If at step 288, the account information matches account information stored by the verification system, then the verification system validates device identifiers (e.g., MAC address, chip/board serial numbers, etc.) associated with the device to determine whether a registered device is attempting to access the account. If at step 292, the verification system determines that device 280 is not registered with the account being accessed, then the verification process fails and the user is not allowed access to the account. If at step 292, the verification system determines that device 280 is registered with the account being accessed, then the verification process succeeds and the user is allowed to associate media content 294 (purchased or otherwise available to the user) with the registered device to create media content/device pairings that define what media content may be accessed by which registered devices.

Having accessed the account, the registered user device may associate media content (assuming the user has purchased or otherwise acquired rights to the media content, perhaps in an online transaction based on credit card/device identifier pairs used to verify the online purchase of media content) with one or more registered devices at step 296, forming content/device pairs that allow the user to access the selected content from the selected registered device. In one embodiment, if the online transaction used to purchase the media content was a verified transaction based on entity (e.g., credit card)/device pairs, then the merchant server/content provider 306 (shown in FIG. 10B) may automatically generate media content/device identifier pairs based on the device identifiers associated with the registered device used to complete the online transaction. This may be true whether the verification system is separate from or included as part of the merchant server/content provider 306.

FIG. 10B illustrates a method by which a user accesses media content associated with one or more registered devices according to an embodiment of the present invention. In particular, this embodiment illustrates an attempt to access media content from a registered device 280 (as shown in FIG. 10A) and an unregistered device 300. Content may have been purchased from content provider authorization account 306, or content provider authorization account 306 may act only as the gatekeeper to media content. Both devices attempt to access media content 302 through user interface 304 by providing entity information identifying the media to be accessed and device identifier information to content provider authorization account 306. The entity/device pairing is compared to records stored by content provider authorization account 306 to determine whether the device is attempting to access media content 302 from a registered device. At step 308, if it is determined that the user is attempting to access the account from unregistered device 300, then access is denied. If the user is attempting to access the account from registered device 280, then access is allowed to the media content associated with the registered device. That is, registered device 280 is allowed to access only the media content with which registered device 280 has been associated through content/device pairs 310.

FIG. 11 is a block diagram illustrating a method of transferring media content between devices according to an embodiment of the present invention. For example, this method could be useful in allowing users to transfer media content between personal devices or transferring or selling media content to a third party.

In the embodiment shown in FIG. 11, authorized device 312 transfers access to media content 314 to unauthorized device 316. In embodiments in which the digital content is stored locally, the transfer may include the transfer of the actual media content as well as the authorization to access the media content. Both the authorized device 312 and the unauthorized device 314 need to be registered with the verification system to allow the transfer of media content rights. Initially, device information identifying device 312 is paired with information identifying media content 314 and stored to form a content/device pair (i.e., entity/device pair) that is used to allow authorized device 312 to access media content 314. Similarly, the lack of stored content/device pair prevents unauthorized device 316 from accessing media content 314. A transaction between authorized device 312 and unauthorized device 316 transfers rights to access media content from authorized device 312 to unauthorized device 316.

To conduct the transaction, authorized device 312, which is paired with media content 314, initiates the transfer of the desired media content by accessing the user's account based in part on the device identifiers associated with authorized device 312. Access to media content 314 is authorized by a content/device pair associated with the user's account. A user selects the media content to be transferred and the content/device pair associated with the selected content is broken as part of clearing process 324. The selected content, no longer paired with a particular device, can now be associated with another device to create a new content/device pair.

As part of the exchange process, registered device 312 identifies the device to be paired with the selected media content.(why not just have 312 get an authorization code from the 320 and send it to 316 who sends it to 322 and is now authorized to access the media content that was exchanged. Its like giving someone a new one time password to associate the content with their device which prevents further associations unless the exchange process is used. Just like when you change devices or add devices in the credit card scenarios except for in an exchange it's change only. Again the key here is pairing the content (or credit card) with the device identifier. In this case, a user would select or otherwise indicate that media content 314 should be associated with previously unauthorized device 316. Device identifiers associated with unauthorized device 316 are paired with the selected content at step 322, thereby allowing unauthorized device 316 (now authorized) to access the selected media content 314.

In another embodiment, authorized device 312 requests transfer of selected media content to another user. In response, exchange process 320 generates an authorization key that is provided to authorized device 312 authorizing the transfer of media content. Registered device communicates the authorization key to unauthorized device 316, which provides the authorization key to exchange process 320. As a result of providing the correct authorization key, exchange process creates a content/device pair associated with the account created by the unauthorized device 316. In addition, the content/device pair associated with authorized device 312 is broken by clearing process 324 in response to the content device pair being created with respect to unauthorized device 316 (now the authorized device).

The present invention provides a consumer-oriented approach to preventing online fraud. In particular, the invention provides the means for a user to register devices with a verification service and selectively associate entity information with one or more of the registered devices. Online transactions require the user to submit the entity information and device identifiers (or, authentication keys representing the paired entity information and device identifiers). The combination is provided to a verification system in which records of paired entity information and device identifiers are stored. The process is verified if the submitted entity/device pair matches a stored record entity/device pair. Based on verification provided by the verification system, a merchant/content provider may determine whether to complete the transaction.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of verifying the validity of entity information, the method comprising:
receiving a request from a user device to create a verification account;
collecting device identifiers from the user device that requested creation of the verification account;
storing the device identifiers in a database to register the device with a verification account;
receiving entity information provided by a user via the user device;
receiving instructions from the user device to associated the entity data with one or more registered devices, wherein combinations of selected entity data and device identifiers are stored as entity/device pairs to the database;
receiving verification requests from a requester that includes an entity/device pair provided by a user to the requestor;
comparing the entity/device pair received from the requester to the entity/device pairs stored in the database; and
sending a notification to the requester indicating either that the entity/device pair is valid if the entity/device pair received from the requester matched an entity/device pair stored in the database or that the entity/device pair is invalid if no match was found in the database.

2. The method of claim 1, wherein collecting device identifiers from the user device includes:
sending to the user device a request to collect device identifiers from the user device; and
receiving an acknowledgement from the user device allowing the collection of device identifiers; and
sending to the user device an applet that automatically collects the device identifiers associated with the user device.

3. The method of claim 1, wherein collecting device identifiers from the user device is done automatically in response to the request from the user device to create a verification account.

4. The method of claim 1, further including:
receiving requests to access a verification account from a user device;
collecting device identifiers associated with the user device;
comparing device identifiers collected from the user device to device identifiers stored to the database to verify the user is attempting to access a verification account from a device registered with the verification account; and
wherein verified users are allowed to register additional devices, deregister devices and modify entity/device pairings associated with the verification account.

5. The method of claim 4, wherein registering one or more additional devices includes:
receiving a request from a registered user device to add an additional device to the verification account;
generating a first authorization code and saving the first authorization code to the database;
sending the first authorization code to the registered user device;
receiving a request from an unregistered user device to access the verification account;
collecting device identifiers from the unregistered user device that requested access to the verification account;
receiving a second authorization code from the unregistered device;
comparing the first authorization code saved to the database with the second authorization code received from the unregistered device; and
registering the previously unregistered device with the verification account if the second authorization code received from the unregistered device matches the first stored authorization code, wherein the unregistered device is registered by storing the device identifiers associated with the unregistered device to the database.

6. The method of claim 1, wherein receiving verification requests from a requester includes receiving a request to access media content, wherein device identifiers associated with a device making the request and the media content requested are compared with entity/device identifier pairs stored in the database and access to the requested media content is allowed if a matching entity/device identifier pair is stored in the database, wherein the entity information includes media content.

7. The method of claim 1, wherein receiving verification requests from a requester includes receiving a request to complete an online transaction using payment source information, wherein device identifiers associated with a device making the request and the payment source information provided by the user are compared with entity/device identifier pairs stored in the database and verification of the online transaction is provided if a matching entity/device identifier pair is stored in the database, wherein the entity information includes the payment source information.

8. A verification system, comprising:
a server operably connected to send and receive communications with user devices, wherein the server receives entity information from user devices and collects device identifiers associated with the user device providing entity information;
a database that stores entity data and device identifiers identifying registered devices, and user defined links between the entity information and the device identifiers received by the server, wherein a user may access, define and modify links between entity information and device identifiers by communicating through the server from a registered device; and
wherein the database is operably connected to receive verification requests from requesting servers, the verification requests including entity/device pairs collected by the requesting server as part of a transaction with a user device, wherein the database sends a verification to the requesting server if a entity/device pair stored in the database matches the entity/device pair provided by the requesting server.

9. The verification system of claim 8, wherein the server includes:
an account creation interface that allows users to create a verification account from an unregistered user device and collects device identifiers from the unregistered user device, wherein account creation includes storing entity information and device identifiers identifying registered devices to the database;
an account login interface that allows a user to subsequently access the verification account from a registered device, wherein the account login interface compares device identifiers collected from a device attempting to access the verification account with device identifiers registered with the verification account to verify access to the verification account; and
an account management interface that receives input from an authorized user that allows a user to add entity information, modify entity information, register/de-register devices, and create or modify links between entity information and registered devices.

10. The verification system of claim 8, further including:
a media content storage database for storing a plurality of media content, the media content storage database operably connected to distribute media content to registered devices, wherein the server verifies distribution of media content based on entity/device pairs provided by a user to the server, wherein the server compares the provided entity/device pairs to entity/device pairs associated with the verification account.

11. A method of preventing fraud by verifying that a transaction is permitted using a device, the method comprising:
receiving entity data information from the user device regarding a proposed transaction;
collecting device identifiers from the user device used by the user to initiate the transaction;
pairing the entity data information submitted by the user device with the device identifiers collected from the device to form an entity/device pair;
communicating the entity/device pair to a verification system that allows users to register devices and pair registered devices with selected entity information; and
comparing received entity/device pairs with the entity/device pairs on the verification system and receiving feedback from the verification system regarding whether the entity/device pair received from a user has been registered on the verification system.

12. The method of claim 11, wherein entity information received from a user includes credit card information.

13. The method of claim 11, wherein entity information received from a user includes media content or the identity of media content accessible by the user device.

14. The method of claim 11, wherein pairing the entity data information with the device identifiers collected from the device includes further pairing the entity information with a transaction amount and encrypting the combination of entity data, device identifiers, and transaction amount for communication to the verification system.

15. The method of claim 14, wherein the feedback received from the verification system includes feedback regarding a location for an unauthorized transaction attempt.

16. The method of claim 11, wherein the transaction is an online transaction.

17. A method of verifying transactions, the method comprising:
sending a request to a verification system to register a device;
receiving a request from the verification system to provide account information and device identifiers associated with the device;
sending the account information and the device identifiers associated with the device to the verification system;
receiving notification from the verification system regarding successful registration of the device;
communicating entity data to the verification system; and
selectively associating the entity data with one or more registered devices to form entity/device pairs.

18. The method of claim 17, further including:
verifying transactions with a requesting merchant by providing an entity/device pair to the requesting merchant for verification of matching entity/device pairs stored by the verification system.

19. The method of claim 18, wherein the entity data communicated to the verification system includes credit card information.

20. The method of claim 18, wherein the entity data communicated to the verification system includes identification of media content.

21. A method of reducing fraud in transactions, the method comprising:
receiving a transaction request from a user device;
sending to the user device a request to payment source information and device identifiers associated with the user device, wherein device identifiers are collected from the user device without manual input from a user;
receiving the collected payment source information and device identifiers from the user device;
sending a verification request to a verification server that pairs the payment source information with the device identifiers collected from the user device;
receiving a notification from the verification server indicating whether the paired combination of payment source information and device identifiers matches a pair of payment source information and device identifiers stored by the verification system, wherein if no match is found then the notification indicates an unauthorized transaction, and wherein if a match is found then the notification indicates an authorized transaction; and
completing the transaction initiated by the user based on the notification received from the verification system.

22. The method of claim 21, wherein the payment source information and device identifiers collected from the user device are provided in the form of an authorization key generated by the verification system during device registration and provided to the user device to complete transactions.

23. The method of claim 21, wherein the transaction is an online transaction.

24. A method of providing verified access to media content, the method comprising:
receiving a request from a user device to access stored media content;
collecting device identifiers associated with a device requesting access to the media content; and
comparing the media content request and the collected device identifiers to stored media content/device identifier pairs to verify access to the requested media content, wherein access to the requested media content is provided only if a matching media content/device identifier pair exists.

25. The method of claim 24, further including:
transferring access to media content from a first registered device to a second registered device, wherein stored media content/device identifier pairs associated with the first registered device are erased and the media content is associated with the second registered device by creating and storing media content/device identifier pairs associated with the second registered device.

26. The method of claim 25, wherein the first registered device and the second registered device are associated with a first user account.

27. The method of claim 25, wherein the first registered device is associated with a first user account and the second registered device is associated with a second user account.
